(19) United States
(12) Patent Application Publication
(10) Pub. No.: US 2025/0276632 A1
(43) Pub. Date: Sep. 4, 2025

(54) VERSATILE BRACKET SYSTEM FOR SECURING CARGO HAVING VARIOUS DIMENSIONS

(71) Applicant: Ancra International LLC, Hebron, KY (US)

(72) Inventors: Howard Thomas KNOX, Cold Spring, KY (US); Joaquim Carlos DA ROSA, Independence, KY (US)

(21) Appl. No.: 19/061,711

(22) Filed: Feb. 24, 2025

Related U.S. Application Data
(60) Provisional application No. 63/559,581, filed on Feb. 29, 2024.

(51) Int. Cl. B60P 7/08

(52) U.S. Cl. CPC B60P 7/0815; B60P 7/0892

(57) ABSTRACT

An improved adjustable bracket system for restraining cargo having various dimensions in a cargo compartment is disclosed. In one example, the system includes a first bracket and a second bracket that can be attached to a wall of a cargo compartment, and the brackets can include hooks for restraining the cargo. The position of at least one of the hooks can be adjusted (e.g., closer to, or further away from, the other bracket) based on the size of the cargo, and at least one of the hooks may also include a locking element or locking member. Methods for securing multiple carts to a wall using the brackets are also disclosed.

### CROSS-REFERENCE TO RELATED APPLICATIONS

This application claims the benefit of U.S. Provisional Application No. 63/559,581, filed Feb. 29, 2024 and entitled “VERSATILE BRACKET SYSTEM FOR SECURING CARGO HAVING VARIOUS DIMENSIONS.” The aforementioned application is hereby incorporated by reference in its entirety.

### BACKGROUND

Cargo compartments employ the use of different components and systems to restrain cargo, such as cargo carts, being transported within the cargo compartment. In some conventional systems, stand-alone beams spanning a full width of the cargo compartment or cargo securement straps are engaged and disengaged from coupling locations in the cargo compartment.

### BRIEF DESCRIPTION OF DRAWINGS

FIG. 1 is a perspective view of a bracket system in accordance with the present disclosure.

FIG. 2 is a perspective view of the track and a first bracket of the bracket system of FIG. 1.

FIGS. 3A-B are a perspective views of the first bracket of the bracket system of FIG. 1.

FIG. 4 is a perspective view of the mounting plate of the first bracket of FIGS. 3A-B.

FIG. 5 is a perspective view of the second bracket of the bracket system of FIG. 1 with the locking member in a first opened position.

FIG. 6 is a perspective view of the second bracket of the bracket system of FIG. 1 with the locking member in a second closed position.

FIGS. 7A-B are perspective views of the second bracket with a portion of cargo inserted with the locking member in the open and closed positions, respectively.

FIG. 8A is a side view of a first cart partially secured to a wall with an example bracket system in accordance with the present disclosure,

FIG. 8B is a perspective close-up of the middle bracket of FIG. 8A.

FIG. 8C is a side view of the bracket system of FIG. 8A with the first cart and a second cart being fully secured.

FIG. 8D is a perspective close-up of the middle bracket of FIG. 8C.

FIGS. 9A-B are perspective views of another example of a first bracket in accordance with the present disclosure.

FIG. 10 is a schematic flow chart of a method of securing two carts to the wall of a cargo compartment, in accordance with the present disclosure.

FIG. 11 is a schematic flow chart of a method of securing three or more carts to the wall of a cargo compartment, in accordance with the present disclosure.

### DETAILED DESCRIPTION

The present disclosure is related to an improved adjustable bracket system for restraining cargo having various dimensions in a cargo compartment. In one example, the system includes a first and second bracket that can be attached to a wall of a cargo compartment, and brackets can include hooks for restraining the cargo. The position of at least one of the hooks can be adjusted (e.g., closer to, or further away from, the other bracket) based on the size of the cargo. As such, the system is more versatile and can more readily accommodate various sized cargo, such as carts with differing lengths.

Cargo compartments employ the use of different components and systems to restrain cargo, such as cargo carts, being transported within the cargo compartment. In some conventional systems, stand-alone beams spanning a full width of the cargo compartment or cargo securement straps are engaged and disengaged from coupling locations in the cargo compartment. In some cases, each of these systems can take a relatively long time to install, remove or store in a safe and organized manner. For example, in a situation where the cargo comprises a plurality of carts, a significant number of straps might be required to adequately restrain the carts individually, and neatly storing the straps after use (e.g., by rolling them up in order to prevent tangling) is also time-consuming.

Some conventional bracket systems use pairs of brackets removably attached to a cargo compartment wall (e.g., a cargo compartment wall having a series of regularly spaced apertures along its length). A first part (e.g., first vertical post or strut) of a cart is inserted into a first hook of a first bracket, and a second part (e.g., second vertical post or strut) of the cart is inserted into a second hook of a second bracket. However, in conventional bracket solutions the adjustability of the spacing between the first hook and the second hook, and thus the size of the carts that can be properly secured, is limited by the spacing between adjacent apertures in the wall. That is, the position of the hook of each bracket is fixed relative to the adapters that connect the bracket to the wall; thus, the position of the hook along the wall can only be changed by attaching the bracket to a different set of apertures, which themselves also have a fixed position. This limits the ability of the brackets to be used with carts having dimensions that don't align with these fixed spacings, leading to either a poor fit resulting in movement and rattling of the cart, or the cart being prevent from be locked within the bracket at all. The method of securing multiple carts along a wall with these conventional brackets also typically uses a pair of brackets to secure the front and back of each cart. Since each bracket requires a certain amount of its own space on the wall, this method may reduce the amount of carts that can be secured along the total usable length of the wall.

In an example of the present disclosure, the hook of at least one of the brackets is moveable relative to a base plate attached to the wall. For example, the hook can be attached to a main plate that is joined to a mounting plate, and the hook and/or the main plate is movable relative to the mounting plate. For example, the main plate and the mounting plate can include complementary corrugated surfaces, and the plates are movable along the complementary corrugated surfaces, which allow for finer incremental positioning of the main plate and the mounting plate relative to each other while providing a connection with strong lateral resistance. In other examples, the mating surfaces can comprise other surface features that allow them to be adjustably mated together. For example, the first surface may comprise one or more teeth or other protuberances. The second side may comprises a corresponding set of protuberances that can interlock with the first protuberances. In a second example, instead of protuberances the second surface may comprise a series of holes into which the first protuberances can selectively be inserted into.

The main plate further comprises a one or more slotted holes extending in the horizontal length of the bracket, which allows the main plate to be adjustably secured to the mounting plate along the length of the slotted hole. In some examples a single slotted hole and fastener may be used. Multiple slotted hoes and corresponding fasteners may provide additional stability and strength.

Methods have also been developed to secure two or more carts along a wall by using fewer brackets that prior methods. In the conventional method, two brackets are used to secure each individual cart; while using a single bracket to secure a cart is known, having at least two points of connection may be desired when, for example, the cargo is relatively heavy, putting undue stress on the single point of attachment.

In an example of the method according to the present disclosure, a first bracket restrains a first post of a first cart that is at the front of a row of carts that abut each other. A second bracket releasably restrains and locks a second post of the last cart in the row of carts. In between, a plurality of brackets each restrain a pair of posts in their respective hooks, one from each of adjacent carts that abut each other. Because the carts abut each other, restraining the first and last carts in the axial (forward/backwards) direction serves to restrain all the carts in the row in the axial direction, and the hooks of the intervening brackets restrain the carts from movement in the lateral (side-to-side) direction. Since the method allows for but does not require the intervening brackets to have locking members, loading and unloading the carts is made simpler and faster, and there is more flexibility in using the brackets available to properly secure the cargo. In addition, the brackets may be manufactured so that their directionality is interchangeable; that is, each bracket can be oriented to be used on either wall, in the forwards or backwards direction; the locking member is also configured to have its directionality readily adjusted. This further increases the system's flexibility in being configurable to adapt to different types of cargo.

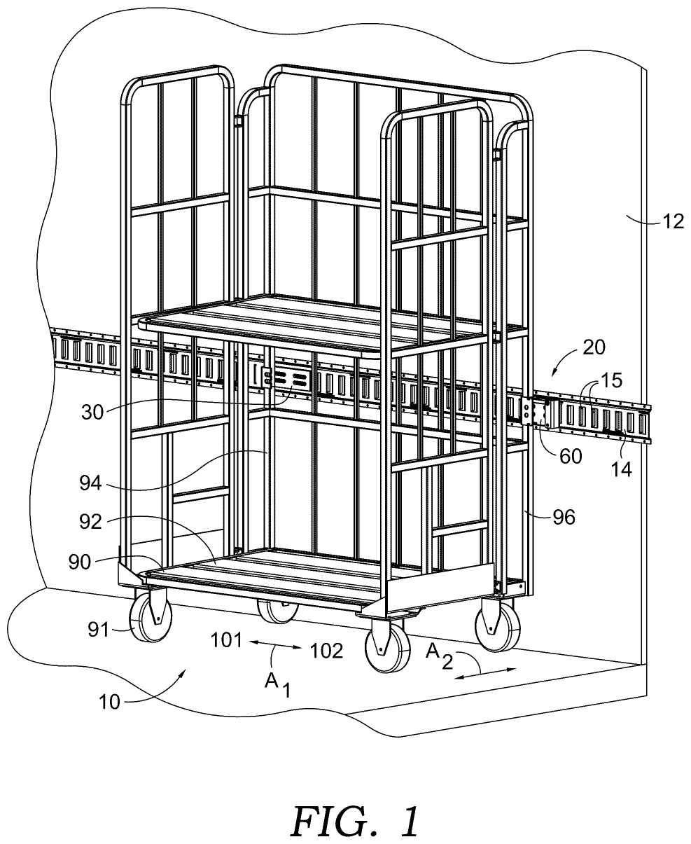

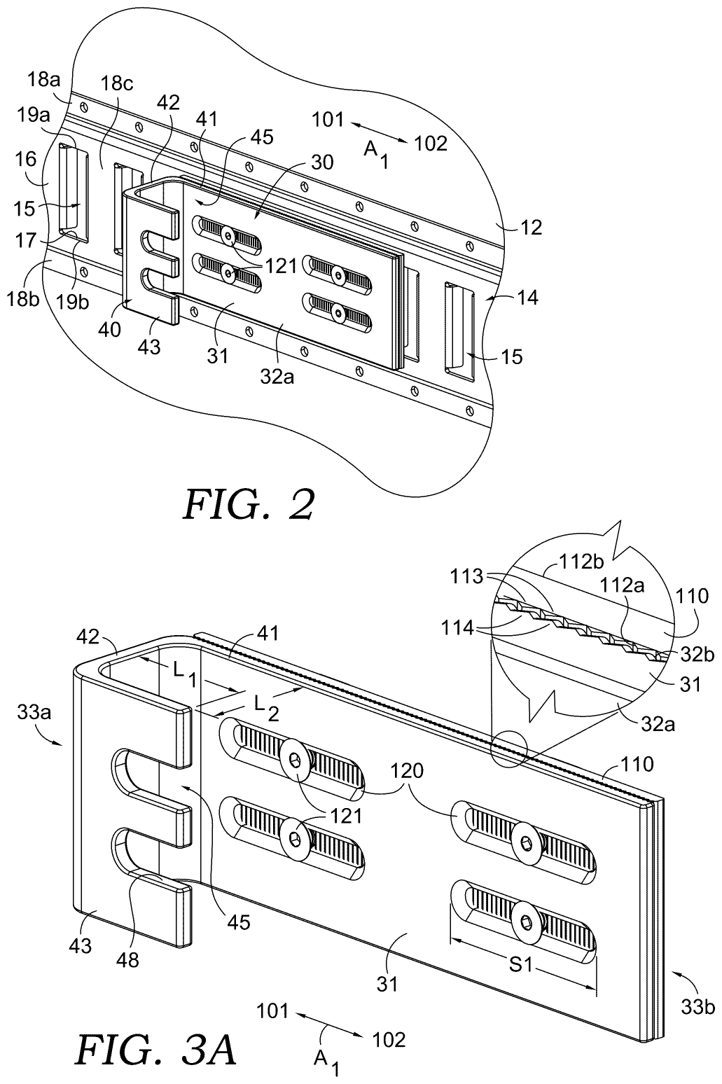

Referring to FIGS. 1-2, a first embodiment of a system 20 for restraining cargo 90 within a cargo compartment 10 is provided. As depicted in FIG. 1, the cargo compartment 10 may be for a truck, a trailer, a cargo van, an intermodal container, a rail car, a compartment on a boat or aircraft or the like. While any of these types of cargo compartments can successfully receive the system 20, the system 20 will be described and depicted in detail as installed and used within the cargo compartment of a truck. One of ordinary skill in the art with a thorough review of this specification and figures will readily understand that the system 20 can be adapted for other types of cargo compartments and would be able to implement the system 20 in other types of cargo compartments.

Moreover, while many types of cargo 90 can successfully be restrained by the system 20, the cargo 90 will be described and depicted herein as one or a plurality of carts 90, such as example cart 90 in FIG. 1. One of ordinary skill in the art with a thorough review of this specification and figures will readily understand that the system 20 can be adapted for other types of cargo and would be able to implement the system 20 with other types of cargo (such as boxes or pallets), in addition to carts.

The system 20 comprises at least one bracket, and in the example of FIG. 1 a plurality of brackets, in particular a first bracket 30 and a second bracket 60, that are adapted to be adjustably mounted within the cargo compartment 10, and coupled to a sidewall 12 of the cargo compartment 10, as explained in further detail below. A fixed track 14 having a plurality of spaced-apart apertures 15 may extend along the sidewall 12, as depicted in FIGS. 1 and 2. In the example of a cargo compartment of a truck, it will be appreciated that the truck comprises an opposing sidewall (which is not depicted in the views of FIGS. 1-2), and that another horizontal track with apertures may be disposed on that opposing sidewall and used in a similar manner. As described herein, the cargo compartment 10 comprises a main axis A1 (e.g., longitudinal axis or orientation) extending in the forward direction 101 and the rearward direction 102 within the cargo compartment, and a lateral axis A2 extending in a direction from the sidewall 12 toward an opposite sidewall, as depicted in FIG. 1. As explained further below, the system 20 is capable of restraining movement of cargo in forward direction 101 and rearward direction 102 along the main axis A1, and further restraining lateral movement of the cargo along the lateral axis A2.

The track 14 may be one of a plurality of lengths of stationary logistics track, such as “A” or “E” track, which are well known in the art and can be rigidly mounted to the walls or floor of a cargo compartment, or to a storage facility. In the example systems herein, the track 14 is depicted as being a horizontally aligned track that is mounted to the sidewall 12 of the cargo compartment 10. In some embodiments, a plurality of tracks 14 may be disposed upon multiple walls of the cargo compartment 10, or each wall of the cargo compartment 10, to allow for flexibility in the arrangement of the cargo 90, which is releasably mounted to the tracks 14 for desired storage and transport purposes.

To aid in the understanding of the disclosure, the terms “forward” or “front” will refer to the direction 101 towards the front of the cargo compartment 10, and the term “rearward,” “back,” “backwards,” etc., will refer to the direction 102 towards the back or rear of the cargo compartment 10. Moreover, the terms “inner” or “inward” will refer to the direction from the sidewall 12 in FIG. 1, and the terms outer” or “outward” will refer to the direction away from the interior and towards the sidewall 12.

The plurality of apertures 15 may extend from a front surface 16 of the track 14 and through the track to a rear surface 17 of the track 14, as best depicted in FIG. 2. The apertures 15 are disposed in a spaced relationship along the length of the track 14, such as at equal spacing from each other. However, other spacings are also within the scope of the present disclosure.

In some embodiments, as best shown in FIG. 2, the track 14 may include first and second portions 18a and 18b that are secured to a mounting surface such as sidewall 12 of the cargo compartment 10. The track 14 may further comprise a central portion 18c, which protrudes inward of the first and second portions 18a and 18b, in order to create a space behind the central portion 18c when the track 14 is secured to the sidewall 12. In the example of FIG. 2, the central portion 18c of the track 14 includes the plurality of apertures 15.

As will be explained in further detail below, each of the first bracket 30 and the second bracket 60 may comprise, or be coupled to, at least one adapter 50, which is configured to secure the respective first bracket 30 and second bracket 60 to the track 14 in the cargo compartment 10. The first bracket 30 and second bracket 60 work in conjunction with one another to help restrain movement of the cargo 18 in various directions, as will be explained in further detail below.

Referring to FIGS. 3A-B, further features of the first bracket 30 are shown and described. The first bracket 30 comprises a main plate 31 having an inner side 32a (e.g., configured to be oriented towards the inside of the cargo compartment when the first bracket is affixed to a side wall) and an outer side 32b (e.g., configured to be oriented towards the side wall when the first bracket is affixed to the side wall), and further having forward and rearward end regions 33a and 33b, respectively (e.g., where the forward end region 33a can be oriented towards the front of the cargo compartment when installed and the rearward end region 33b can be oriented towards the rear of the cargo compartment when installed). In this example, the main plate 31 comprises a generally rectangular shape having a greater horizontal length relative to its vertical height, as depicted in FIGS. 3A and 3B.

The first bracket 30 comprises a hook 40 at its forward end region 33a. In one example, the hook 40 may comprise a generally U-shape that includes an outer segment 41, an end segment 42 and an inner segment 43, as depicted in FIGS. 3A-3B. The outer segment 41 may extend beyond the inner length L1 of the inner segment 43. In the example of FIGS. 3A-B, the outer segment 41 is integral with the main plate 31. The hook 40 is one type of hook, and in other examples, the hook can have other equivalent deigns and configurations.

The end segment 42 of the hook 40 extends at an angle from the outer segment 41. In the example shown, the end segment 42 is relatively straight and extends an inner length L2 that is substantially perpendicular relative to the outer segment 41, although it will be appreciated that the end segment 42 may include a slight concave curvature, or be at an angle different than 90 degrees relative to the outer segment 41.

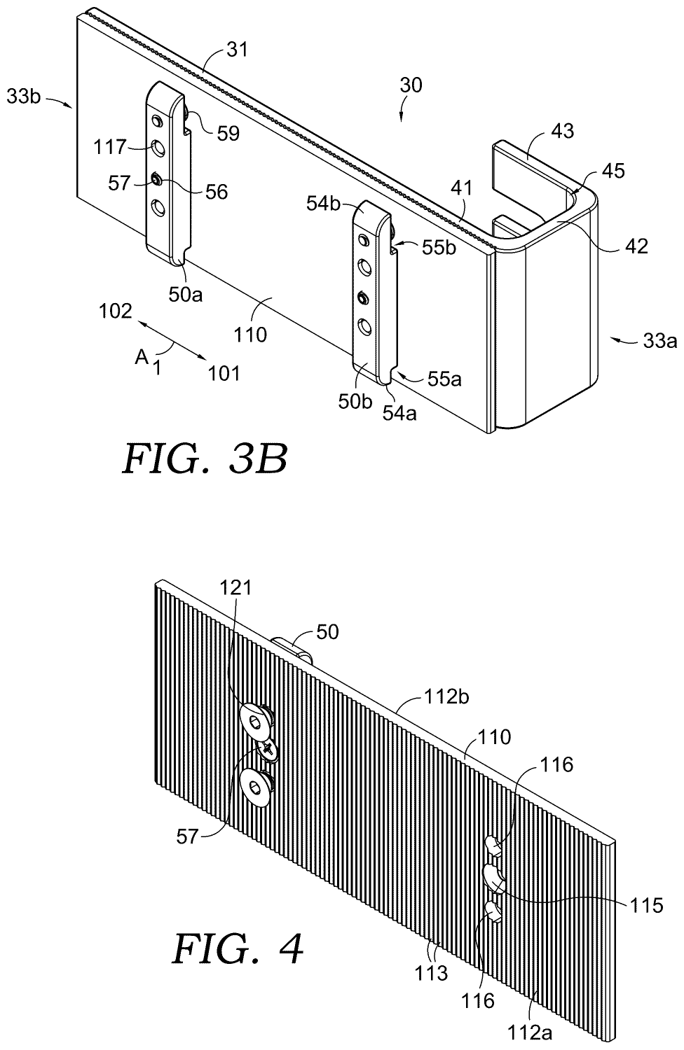

The inner segment 43 of the hook 40 extends from the opposite end of end segment 42 at an angle, which may be perpendicular to the end segment 42, such that the inner segment 43 becomes substantially parallel to the outer segment 41, as shown in FIGS. 3-4. The inner segment 43 may have an inner length L1 from the end segment 42.

In this manner, a receiving space 45 is formed between the outer segment 41, the end segment 42 and the inner segment 43 of the hook 40. As depicted in FIG. 3, and will be explained in further detail below, the receiving space 45 is dimensioned to receive a portion of the cargo 90, such as a strut 94 of a cart 90 as depicted in FIG. 1.

In one non-limiting example, the length L1 provided by the outer segment 41 and inner segment 43 may be greater than an axial length (e.g., outer diameter or tubular OD as measured in a direction generally aligned with A1) of the strut 94 of the cargo 90, and further the length L2 provided by the end segment 42 may be greater than a lateral length (e.g., outer diameter or tubular OD as measured in a direction generally aligned with A2) of the strut 94 of the cargo 90. In this manner, the entirety of the strut 94 may be disposed within the boundaries of the receiving space 45 of the hook 40, as shown in FIG. 1 and explained further below.

The main plate 31 is affixed to a mounting plate 110. The mounting plate 110 has a first side or inner side 112a and an opposite second side (or outer side) 112b. In the example of FIGS. 3A-3B and 4, the first side 112a comprises a series of rows 113 (e.g., projections or as a serrated face) protruding outwardly from the first side 112. The rows 113 may be parallel to each other and oriented in a generally vertical direction. The outer side 32b of the main plate 31 also comprising a corresponding set of rows 114 (e.g., projections or as a serrated face) oriented parallel to the rows 113 of the first side 112a, such that the two sets of rows can interlock with each other. The first side 112a of the mounting plate 110 and the outer side 32b of the main plate 31 can thus be interlocked in a plurality of different positions relative to each other in the longitudinal axial direction A1, with the interlocked rows providing resistance against a shearing force in the longitudinal axial direction A1.

When the rows 114 of the main plate 31 and the rows 113 of the mounting plate 110 are aligned so that they can be interlocked, the main plate 31 and the mounting plate may be secured to each other by one or more fasteners 121 inserted through slotted holes 120 in the main plate 31 and secured into holes 116 in the mounting plate. In some embodiments, the holes 116 may be tapped to receive the threads of a correspondingly threaded fastener 121 that may be used to releasably couple the main plate 31 to the mounting plate 110. The slotted holes each have a length S1 oriented in the longitudinal axial direction A1.

In examples, the main plate 31 and the mounting plate 110 can be secured in a variety of positions relative to each other based upon the length S1 of the slot and the dimensions of the rows 113 and 114 of the corrugated surfaces (e.g., serrated face). That is, the finer the corrugations (i.e., the thinner the width of the rows in the axial direction), the more discretely the positioning of the main plate 31 relative to the mounting plate can be adjusted in the longitudinal axial direction A1, and the length of the slots S1 determines the maximum extent in either axial direction that the main plate 31 and the mounting plate 110 can be secured to each other while still being securable by the fasteners 121.

In the example of FIG. 3A, the slotted holes 120 are chamfered, so that a corresponding angled head of the fasteners 121 can be countersunk to be even with or under the inner side 32a of the main plate 31, so that the fastener heads do not interfere with the positioning of the cargo 90 into or out from the receiving space 45.

As shown in the example of FIG. 3B and FIG. 4, the holes in the mounting plate 110 may be aligned with the holes 115 for securing the adapters 50a, 50b, and the adapters 50a, 50b is also configured with a corresponding hole 117. Longer fasteners 121 can thus be used to more securely fasten the main plate 31 to the combined mounting plate 110 and adapters 50a, 50b, providing greater overall strength to the assembled first bracket 30.

While the example shown in FIGS. 3A-3B and 4 show a main plate 31 and mounting plate 110 with complementary mating surfaces comprising serrated faces having evenly spaced rows, other variations are also within the scope of the present disclosure. For example, protuberances other than rows can extending from one of the surfaces and interlock or interdigitate with protuberances, holes, or other features on the complementary surface. Furthermore, the protuberances may be oriented in a direction other than as shown in FIGS. 3A-3B and 4. It is also to be readily appreciated that the two mating surfaces can be substantially smooth and flat (e.g., no discernable surface features), but rely upon friction once the main plate 31 and the mounting plate are secured with each other to prevent movement relative to each other in the axial direction.

Additionally, in other examples alternative locking mechanisms can be used to releasably and adjustably lock the parts of the first bracket 30 together. For example, a spring-biased plunger, or a gear mechanism could be used.

The positioning of the main plate 31 relative to the mounting plate 110 can be adjusted when the first bracket 30 is on the wall or prior to being affixed to the wall. Moreover, it is readily appreciated that the fasteners 121 do not need to be fully removed in order to adjust the positioning of the main plate 31, just loosened (e.g., unscrewed) to the extend needed in order to separate the corrugated surfaces from each other enough so that they do not interfere with the axial repositioning and securing of the main plate 31 relative to the mounting plate 110.

As shown in the example of FIG. 3A, two cutouts 48 are provided in the inner segment 43 of the hook 40 and are aligned with the slotted holes 120 in the main plate 31. The cutouts 48 allow the fasteners 121 to be easily accessed (e.g., by a tool such as a driver (screwdriver) extending through the slotted holes 120) along the entire length of the slotted holes 120. While the shape of the cutouts 48 in FIG. 3 generally correspond to the shape of the portions of the slotted holes 120 that align with the inner segment 43, it is readily appreciated that other shape may also be used.

An example adapter 50 suitable for use with the first bracket 30 and second bracket 60 may be seen in FIGS. 3B and 4. The adapter 50 includes a main body 51 and a first tooth 54a that extends downwardly from the main body 51. The tooth 54a is formed with a depth less than a depth of the main body 51, such that the tooth 54a defines a void 55a between a front surface of the tooth 54a and the bracket to which it is attached (e.g., the outer side 112b of mounting plate 110). In some examples, the void 55a is formed with a depth just larger than a thickness of the material that forms the track 14 (and specifically the thickness of the material forming the portion of the track 14 that defines the plurality of apertures 15).

The adapter 50 may further include a second tooth 54b extending from the upper region of the main body 51. The second tooth 54b may be similar to the first tooth 54a in various ways, e.g., the second tooth 54b comprises a void 55b that may be similar to the void 55a explained above with respect to the first tooth 54a. The adapter 50 may also include an engagement device 59, which is optionally removable or non-removable, which includes a head that extends into the void 55b.

As shown in FIG. 3B, the adapter 50 is coupled to the outer side of a bracket, such as outer side 32b of the mounting plate 110. In this embodiment, two substantially identical adapters 50a and 50b are spaced-apart along the main longitudinal axis A1 of the outer side 112b of the mounting plate 110, as shown in FIG. 4. The adapters 50a, 50b, may be attached to the mounting plate 110 using fasteners 57 through holes 116 in the mounting plate 110 and holes 56 in the adapter 50. The adapter 50 is configured received within an aperture 15 in the track 14 such that the lower edge 19b of the aperture 15 is received within the void 55a, and the head of the engagement device 59 is configured to interact with the upper edge 19a of the aperture 15 so as to substantially prevent the adapter 50 from being translated in a direction along the vertical axis of the aperture 15.

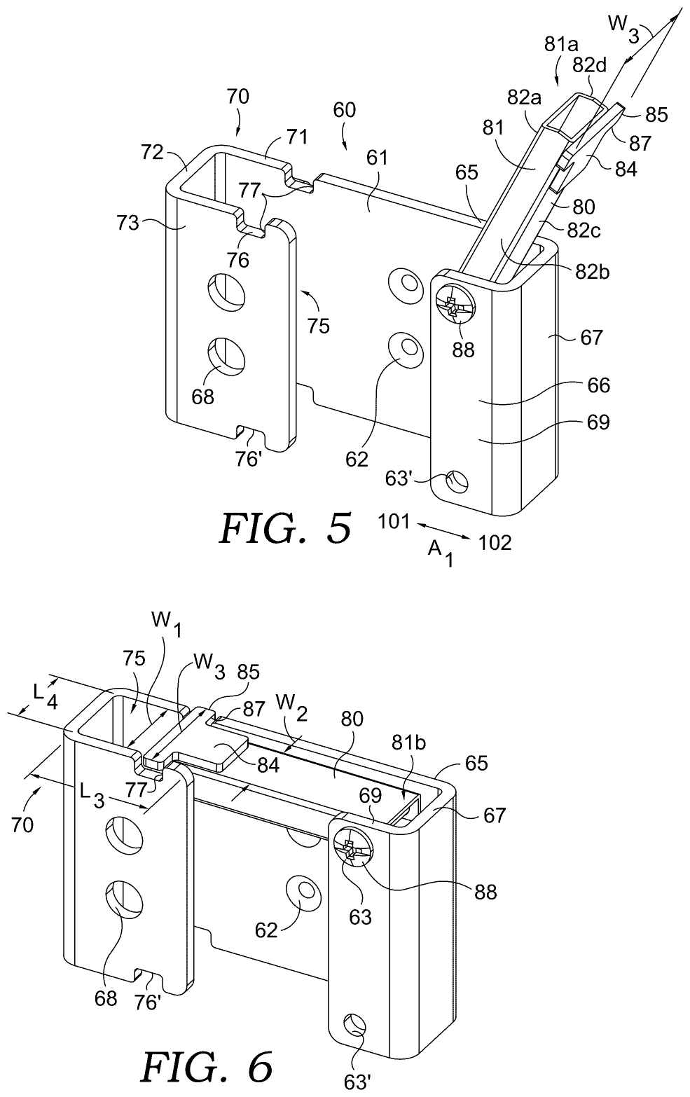

Referring to FIGS. 5-6, further features of one embodiment of the second bracket 60 are shown and described. In this embodiment, the second bracket 60 may be similar to the first bracket 30 as explained in detail above, although certain distinctions of the second bracket 60 will be illustrated further.

The second bracket 60 may comprise a main plate 61 and a hook 70, which correspond to the main plate 31 and the hook 40 of the first bracket 30, respectively. Moreover, the second bracket 60 may comprise one or more adapters 50, which may correspond to the adapters 50a and 50b described in detail above with respect to the first bracket 30.

Like the hook 40 of the first bracket 30, the hook 70 of the second bracket 60 may have an outer segment 71, an end segment 72 with inner length L4 and an inner segment 73 with inner length L3. The inner segment 73 may also have cutouts 68 to allow access (e.g., via a driver) to the fasteners 57 that secure the adapter 50 to the main plate 61.

The second bracket 60 additionally comprises a locking element or locking member 80, which has an open state as shown in FIG. 5, and a closed state as shown in FIG. 6, to facilitate securement of a portion of the cargo 90 (such as a second or rearward strut 96 of a cart 90) within a receiving space 75 of the hook 70. In the example shown, the locking member 80 rotates in a counterclockwise direction (e.g., based on the view in FIGS. 5 and 6) between the open state and the closed state, although it will be appreciated that other axial or rotational movements may be used to transition the locking member 80 between open and closed states.

As shown in FIGS. 5-6, the locking member 80 comprises a main body 81 that extends along a primary axis between a first end 81a and a second end 81b. In this example, the main body 81 comprises a hollow square cross-section, although it will be appreciated that other shapes besides a square cross-section may be used, and various portions of the main body may be solid.

The locking member 80 comprises four main sides 82a-82d. The first side 82a third side 82c are opposing one another, and comprise a width W2. The width W2 may be slightly smaller than a width W1 of the receiving space 75 of the hook 70, where the width W1 extends between the outer segment 71 and inner segment 73 of the hook 70 as depicted in FIG. 5. In some embodiments, the width W1 may approximate the length L2 of the end segment 72 of the hook 70, as the length L2 was explained in FIG. 4). In this manner, the width W2 of the locking member 80 will be allowed to pass into a portion of the greater width W1 of the receiving space 75 of the hook 70.

The locking member 80 may comprise holes in the second side 82b and the fourth side 82d, through which a main shaft of the pivot pin 88 extends, whereby the tolerance is relatively small such that the locking member 80 can only rotate relative to the pivot pin 88. In alternative embodiments, slotted holes may be used instead so that the locking member 80 can also shift axially relative to the pivot pin 88. In examples, a spring or other biasing members can be used to bias the locking member 80 of the second bracket 60 in the closed or locked state. Springs such as torsion springs, compression springs, and coil springs or compressible materials such as foam can be used to provide the biasing actions.

A stop member 84 may be disposed on the third side 82c near the second end 81b of the locking member 80 to limit movement of the locking member 80 in the closed state. The stop member 84 comprises at least one dimension that extends laterally beyond the periphery of the third side 82c. For example, the stop member 84 may comprise a continuous T-shaped member with a cross-bar portion 85 having a width W3 that is greater than the width W2 of the third side 82c of the locking member 80, as depicted in FIG. 5. In this manner, the greater width W3 of the cross-bar portion 85 will catch upon the upper surfaces 71a and/or 73a of the hook 70 in the closed state, as depicted in FIG. 6.

A second end structure 66 may be positioned on the main plate 61 at the end opposite the hook 70. The second end structure 66 is open at its inward-facing side, and comprises an outer segment 65, an end segment 67 and an inner segment 69. The inner segment comprises a hole 63 through which a pivot pin 88 extends laterally and through holes in the second side 82b and the fourth side 82d of the locking member; the end of the pivot pin 88 may be secured to the outer segment 65, e.g., by screwing, welding or other means. The enlarged head of the pivot pin 88 sits beyond the outer surface of the inner segment 69, thereby capturing the locking member 80, while allowing for selective rotational movement of the locking member 80 relative to the pivot pin 88.

As can be seen in FIGS. 5-6 and 7A-B the locking member 80 is limited in its rotation in one direction by the top edge of the end segment 67 of the second end structure 66 (FIG. 5) and in the other direction by the upper edges of the front hook 70 (FIG. 6).

In examples of the present disclosure, the top edges of the outer segment 71 and inner segment 73 of hook 70 may include cutouts or slots 76 into which the ends of the cross-bar portion 85 may fit into when the locking member 80 is positioned in its closed position, with the rearward edges 87 of the cross-bar portion 85 abutting the rearward edges 77 of the slots 76. These additional points of contact between the locking member 80 and the rest of the second bracket 60 are capable of providing a normal force against a force in the rearward or backwards direction 102 along longitudinal axis A1. The slots and cross-bar portion 85 thus help to better distribute forces (e.g., load stresses) experienced by the locking member 80 in the locked position when it resists movement of a locked cargo 90 in the rearward or backwards direction 102, instead of all of the axial forces being solely resisted by the connection of the locking member 80 with the pivot pin 88.

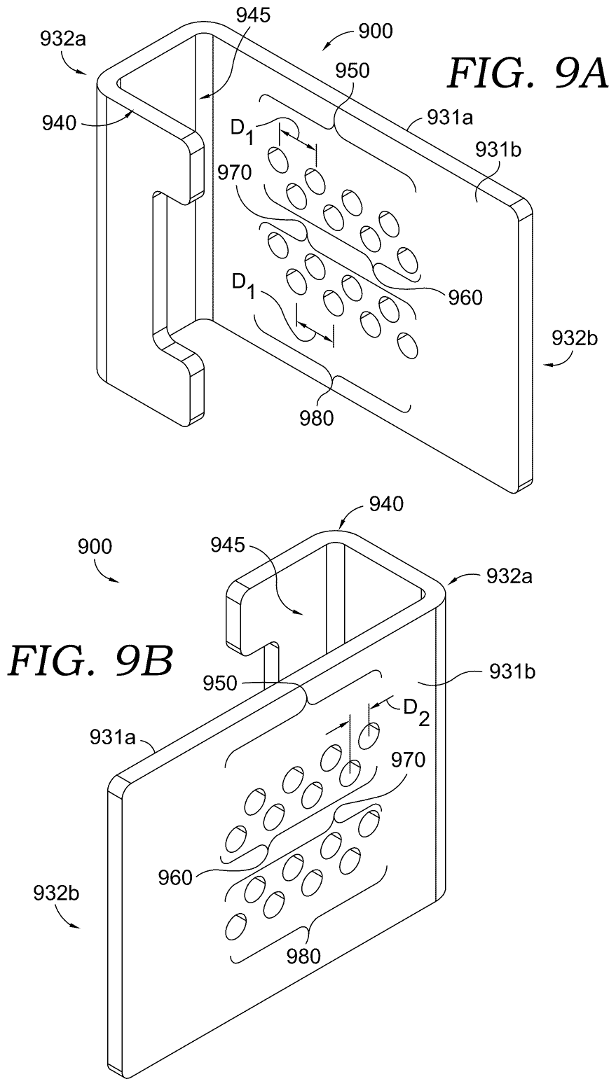

FIGS. 9A-9B depicts an example alternative first or front bracket 900, which uses a different approach to providing greater adjustability of the hook of the bracket in the longitudinal axial direction. Front bracket 900 comprises a main panel 930 having an outer side 931a and an inner side 931b, a first end 392a and a second end 932b. A hook 940 extends from the first end 932a in a manner similar to the hook 40 of first bracket 30 described above.

The main panel 930 has four rows of horizontal holes; first row 950, second row 960, third row 970, and fourth row 980. In the example of FIGS. 9A-9B the holes in each row are spaced apart evenly in the longitudinal direction, with the centers of each hole being a distance D1 apart from the adjacent holes in the row. The holes in the first row and the holes in the second row are staggered or offset from each other in the longitudinal direction so that a hole from one row is positioned halfway in longitudinal direction between the nearest holes in the adjacent row, that is, the distance D2 in FIG. 9B is one half the distance D1. Furthermore, in the example of FIG. 9A-9B, the centers of the holes in the first row 950 line up vertically with the holes in the third row 970, and the holes in the second row 960 line up vertically with the holes in the fourth row 980. While the distance between the holes in FIGS. 9A-9B are uniform, other types of spacing may also be used.

The rows of holes allow the bracket to be affixed to an adapter, such as the adapter 50 described above, so that the bracket can be mounted into an aperture. In the example of FIGS. 9A-9B, a single adapter can be used, but other examples can use multiple adapters.

The adapter 50 can be affixed to holes in the first row 950 and third row 970, or holes in the second row 960 and fourth row 980. Thus, the front bracket 900 can be mounted on a track, such as track 14 in FIG. 2, in one of a plurality of securement positions corresponding to the paired holes, with the position of the hook 940 being adjustable in the longitudinal axial direction A1 in increments equal to the spacing D2 between the centers of adjacent holes in the staggered rows (e.g., first row 950 and second row 960). While the vertical positioning of the front bracket 900 will be different depending upon the pair of rows that the adapter is secured to, the ability of the hook 940 to secure cargo is not substantially impacted by this difference in vertical positioning. As with the hook 40 of first bracket 30, the hook 940 may have a cutout to allow for easier access to the rows of holes 950, 960, 970, 980.

In the example of FIGS. 9A-9B, the front bracket 900 may be secured to the adapter using buttonhead screws. In other examples, flathead screws can be used in combination with countersunk holes. Also, while the example of FIGS. 9A-9B disclose screws to attach the adapter 50 to the front bracket 900, other fastening systems may also be used.

While the example of FIGS. 9A-9B shows this configuration of holes with a front bracket 900 (e.g., a bracket without a locking mechanism), a similar configuration may also be used with a bracket that includes a locking element or locking member, such as second bracket 60 with locking member 80 in FIG. 5.

Additionally, the brackets of the present disclosure may be manufactured so that they can readily be used on either side wall of a cargo compartment in either direction. For example, each of first bracket 30, second bracket 60, and front bracket 900 is configured so that they are generally symmetrical about a central horizontal plane, and the second bracket 60 has corresponding hole 63′ and slot 76′ so that locking member 80 can be secured in hole 63′ instead of hole 63 and secured in a locking position within slot 76′. As the adapters 50 can likewise be secured to the brackets in an inverted position, each bracket can thus be rotated so that the hook is positioned on the opposite side of the bracket relative to the wall to which it is secured. While the row of holes in front bracket 900 are not strictly symmetrical about its central horizontal plane, as noted above this does not impact its ability to be used in either orientation.

An example method of using the system 20 of FIGS. 1-6 to secure one or more pieces of cargo 90 within the cargo compartment 10 will be explained further, together with FIGS. 1-6 and FIGS. 7A-7B. In a first step, a first bracket (e.g., first bracket 30) and a second bracket (e.g., second bracket 60) may be coupled to a track (e.g., track 14) along a wall at spaced-apart axial locations. Specifically, the adapters 50 of the first bracket 30 and the second bracket 60 engage apertures 15 in the track 14, as explained in above, thereby securely coupling each of the first bracket 30 and the second bracket 60 along the track 14 at a predetermined distance (which may correspond roughly to securement locations of the cargo, as shown and explained). The positioning of first bracket hook 40 relative to the second bracket hook 70 may also be adjusted further by adjusting the positioning of the main plate 31 relative to the mounting plate 110.

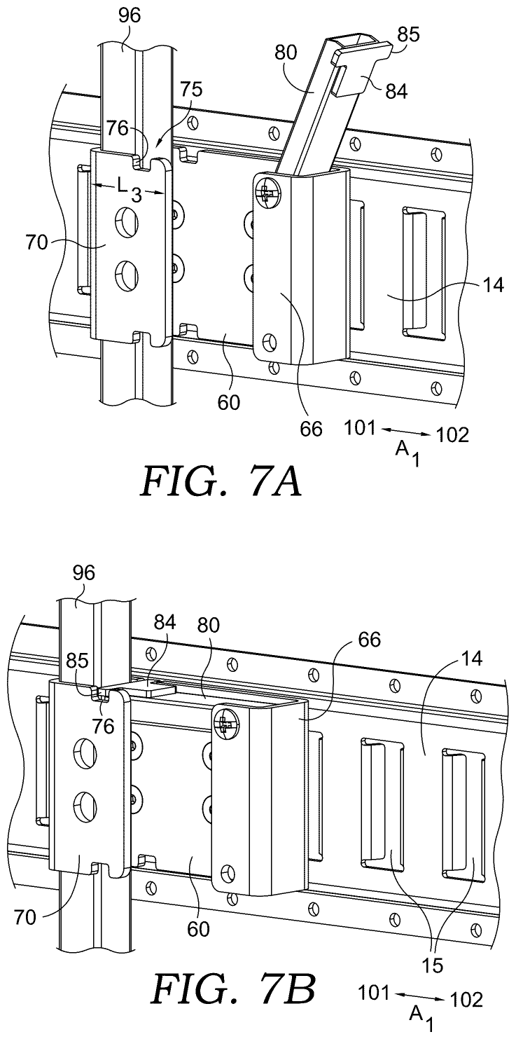

In a next step, a piece of cargo 90, such as cart 90 in FIG. 1, is maneuvered in the cargo compartment (optionally via movement with wheels 91, and with or without items already stored on a surface 92) until an outer region 93 of the cargo 90 approaches the sidewall 12 of the cargo compartment 10. The cart 90 then may be pushed adjacent to or abutting the sidewall 12 of the cargo compartment, such that a first or forward strut 94 of the cart 90 may be disposed slightly rearward of the hook 40 of the first bracket 30, and a second or rearward strut 96 of the cart 90 may be disposed slightly rearward of the hook 70 of the second bracket 60. Then, the cart 90 is pushed forward (while remaining close to or abutting the sidewall 12) such that the first strut 94 enters into the receiving space 45 of the hook 40 of the first bracket 30, as depicted in FIG. 1, and simultaneously the second strut 96 enters into the receiving space 75 of the hook 70 of the second bracket 60, as depicted in FIG. 7A.

In a next step, the locking member 80 of the second bracket 60 is then rotated from the open state of FIG. 7A to the closed state of FIG. 7B. At this time, all sides of the rearward strut 96 of the cart 90 are effectively captured within the receiving space 75 of the hook 70.

In this state of FIGS. 1-2 and FIG. 7B, the cart 90 is securely engaged against the sidewall 12 of the cargo compartment 10, and is prevented from both forward and lateral movement by the first bracket 30, and further prevented from forward, rearward and lateral movement by the second bracket 60.

In further alternative embodiments, it will be appreciated that the hooks 40 and 70 may be located at the rearward regions of the first bracket 30 and second bracket 60, respectively, and the locking member 80 may be disposed near the forward region of the second bracket 60, such that the design of the system is performed in a mirror-image manner, where the cargo 90 would then be loaded into engagement with the first bracket 30 and second bracket 60 in a forward to rearward direction (the opposite of the direction explained in the non-limiting example above).

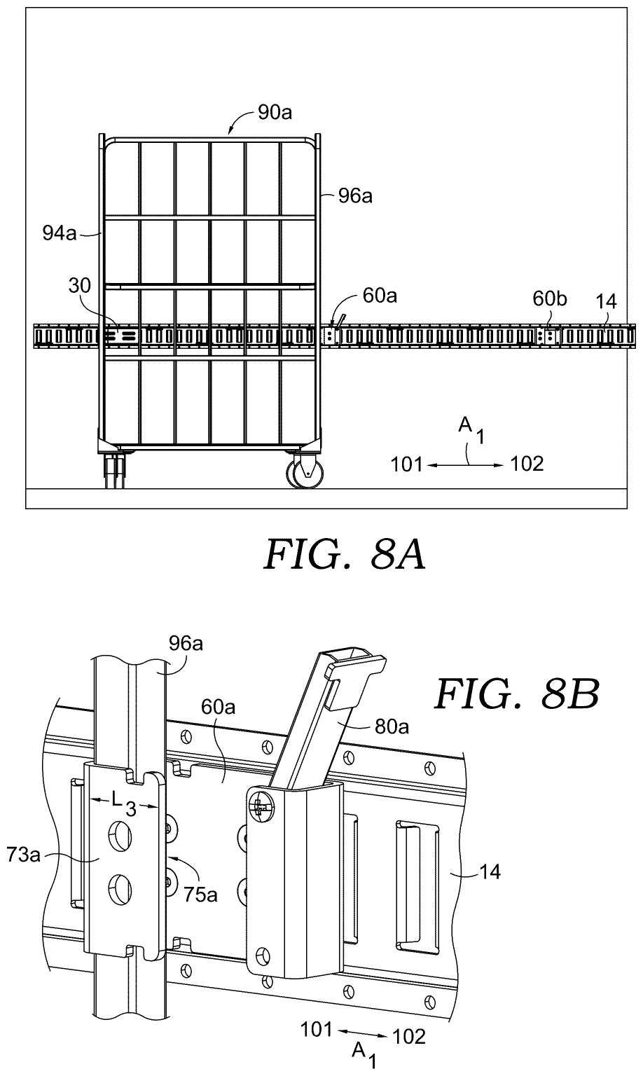

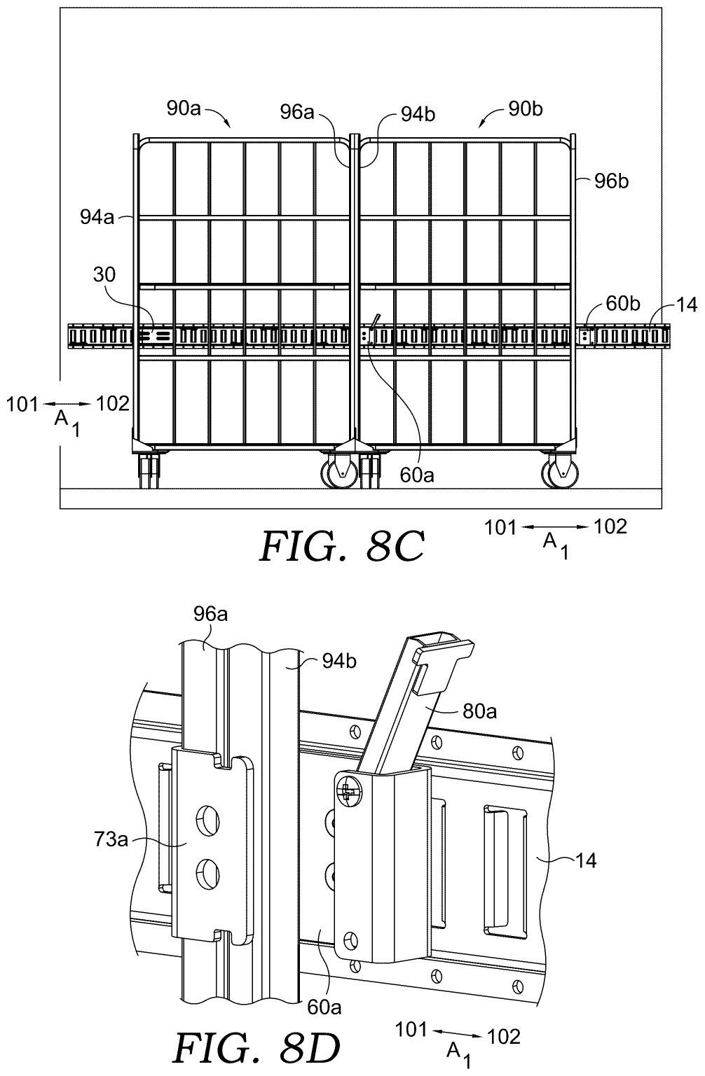

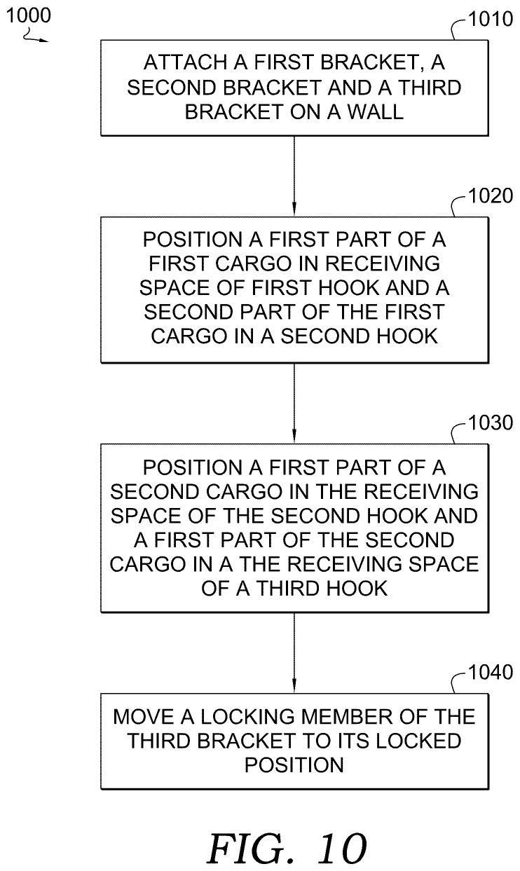

A method 1000 of securing a pair of carts to a wall using only three brackets is described herein with reference to FIGS. 8A-D and the flow chart of FIG. 10. In a first step 1010, as depicted in FIG. 8A a first bracket (e.g., first bracket 30), a second bracket (e.g., second bracket 60a), and a third bracket (e.g., third bracket 60b) attached to a wall. In step 1020, a first cart (e.g., first cart 90a) is then positioned along the wall so that a first strut of the cart (e.g., first strut 94a) is inserted into the receiving space of the first hook (e.g., receiving space 45 of first hook 40), and a second strut of the first cart (e.g., second strut 96a) is inserted in the receiving space of the second hook (e.g., receiving space 75 of second hook 70), as shown in FIG. 8B. In the next step 1030, instead of moving the locking member 80a of the second bracket 60a into a locked position, a second cart (e.g., second cart 90b) is then moved into position along the wall so that its first strut (e.g., first strut 94b) is near the opening of the second hook (e.g., second hook 70) and the second strut (e.g., second strut 96b) is near the opening of the hook of the third bracket (e.g., hook 70b of third bracket 60b). The second cart 90b is then shifted laterally so that its first strut abuts the second strut of the first cart within the receiving space of the first hook, with the first strut of the second cart being received at least partially within the receiving space of the second hook, so that the outward segment and inward segments of the second hook are able to restrain the strut in the lateral direction A2. At the same time the second strut of the second cart (e.g., 96b) is inserted into the receiving space of the hook of the third bracket (e.g., 75b of 70b). In step 1040, the third bracket locking member (e.g., 80b) is moved into its locked position. Because the second strut of the first cart and the first strut of the second cart abut each other, the second cart, being locked into place in the longitudinal axial direction A1 by the third hook and its locking member, also acts to prevent the first cart from movement in the rearward direction 102, and the first hook and second hook restrain the first cart from movement in the forward direction 101.

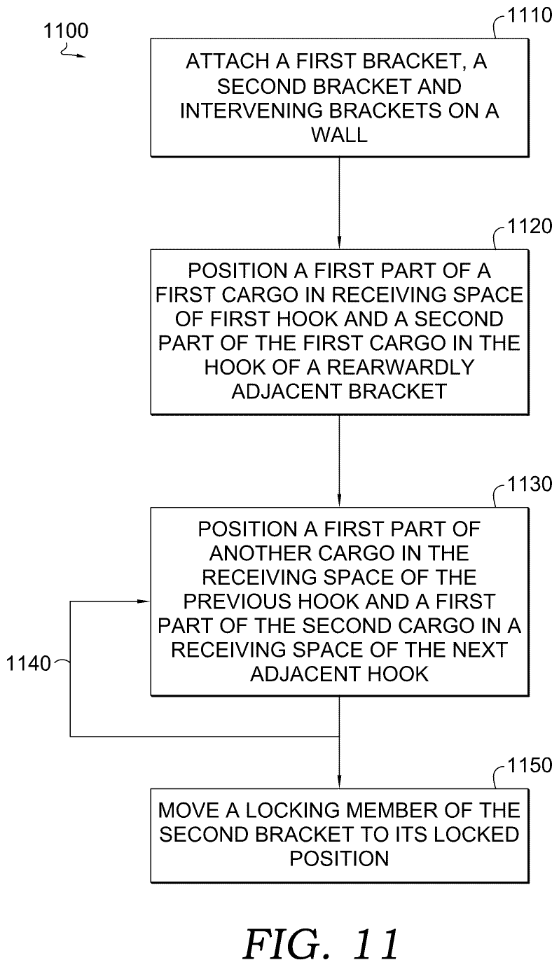

It is readily appreciated that the above method can be expanded to have more than three carts, with the corresponding number of brackets. That is, to secure a number N carts using the above-described method applied in a serial fashion requires only N+1 brackets. As shown in the flow chart of FIG. 11, in a first step 1110 of method 1100 a first bracket, a second bracket, and one or more intervening brackets are attached to a wall, with the intervening brackets positioned between the first bracket and the second bracket. In step 1120, a first part of a first cargo is positioned in the receiving space of the first hook, and the second part of the first cargo is positioned in the receiving space of the hook of the intervening bracket adjacent to the first bracket (the first intervening bracket). In step 1130, a second cargo is then positioned so that the first part of the second cargo is at least partially received in the receiving space of the first intervening bracket and the second part of the second cargo is received into the receiving space of the hook of the next adjacent intervening bracket, with the first cargo and the second cargo abutting each other. In step 1140, the above step is repeated with the additional cargo and intervening brackets until the first part of the last cargo is positioned to be at least partially received in the receiving hook of the last intervening bracket and the second part of the last cargo is positioned within the receiving space of the hook of the second bracket. In step 1150, the locking member of the second bracket can then be moved into its locked position to secure the last cargo, and consequently, the entire row of cargo.

It is to be further appreciated that to practice the above described methods 1000 and 1100, the brackets can be a mixture of brackets that do or do not have locking members, and brackets that do or do not have the adjustability of the first bracket 30 or the front bracket 900 described above. The intervening brackets can be adjustable or can be lockable, as long as the hook front segment (e.g., L3 of 73; L1 of 43) is long enough so that the second post can be at least partially inserted into the receiving space, so that it can be restrained in the lateral direction. The carts, including their struts, may also be of different dimensions, as long as the struts can still fit within the receiving spaces of the hooks and that each hook is dimensioned so that it can capture the strut of one cart plus at least part of another strut.

The following clauses represent example embodiments of concepts contemplated herein. Any one of the following clauses may be combined in a multiple dependent manner to depend from one or more other clauses. Further, any combination of dependent clauses (clauses that explicitly depend from a previous clause) may be combined while staying within the scope of aspects contemplated herein. The following clauses are examples and are not limiting.

Clause 1. A system for restraining cargo in a cargo compartment, the system comprising: a first bracket comprising: a first hook; a mounting plate comprising a first side and an opposing second side; the first hook being releasably affixed to the first side of the mounting plate in one of a plurality of positions along a first linear axis; at least one first adapter affixed to the second side of the mounting plate and configured to be releasably secured to a first location within the cargo compartment; and a second bracket comprising: a second hook comprising a receiving space; at least one second adapter affixed to the second hook and configured to be releasably secured to a second location within the cargo compartment; and a locking member having an open state and a closed state, wherein in the closed state, the locking member obstructs the receiving space.

Clause 2. The system according to clause 1, wherein the first side of the mounting plate comprises a first corrugated surface and a first outer segment of the first hook comprises a complementary second corrugated surface to the first corrugated surface.

Clause 3. The system according to clause 2, wherein the mounting plate and the first hook are affixed to each other with a releasable fastener and slotted hole connection.

Clause 4. The system according to clause 3, wherein the slotted hole is disposed in the first outer segment of the first hook.

Clause 5. The system according to clause 4, wherein the first corrugated surface comprises a first plurality of corrugations with each corrugation having a first longitudinal axis oriented in a vertical direction.

Clause 6. The system according to clause 5, wherein the slotted hole comprises a second longitudinal axis oriented in a horizontal direction and orthogonal to the first longitudinal axes of the first plurality of corrugations.

Clause 7. The system according to any of clauses 1 to 6, wherein the second bracket comprises a second mounting plate comprising a first side and a second side, the second hook is adjustably affixed to the first side of the second mounting plate, and a second adapter is releasably affixed to the second side of the second mounting plate.

Clause 8. The system according to any of clauses 1 to 7, wherein during use, the first bracket is coupled to a track along a wall within the cargo compartment at a predetermined location forward relative to where the second bracket is coupled to the track.

Clause 9. An adjustable bracket assembly for securing cargo, the adjustable bracket assembly comprising: a mounting plate comprising: a first side comprising an anchor for releasably attaching the mounting plate to a wall; and a second side that, relative to the first side, is on an opposite side of the mounting plate; and a bracket that releasably attaches to the second side of the mounting plate, the bracket comprising: a third side facing towards the second side; and a fourth side that, relative to the third side, is on an opposite side of the bracket and that comprises a hook, wherein the second side and the third side are configured to adjustably interlock with each other.

Clause 10. The adjustable bracket assembly according to clause 9, wherein the second side comprises a first protuberance.

Clause 11. The adjustable bracket assembly according to clause to 10, wherein the third side comprises a third side surface structure that is configured to adjustably interlock with the first protuberance.

Clause 12. The adjustable bracket assembly according to clause 11, wherein the third side surface structure comprises least one second protuberance.

Clause 13. The adjustable bracket assembly according to any of clauses 9 to 12, wherein the mounting plate comprises a first aperture, the bracket comprises a second aperture, and the adjustable bracket assembly comprises a releasable fastener coupled to the first aperture and the second aperture.

Clause 14. The adjustable bracket assembly according to clause 13, wherein the second aperture comprises an elongated slot.

Clause 15. The adjustable bracket assembly according to clause 14, wherein the elongated slot comprises a countersink.

Clause 16. The adjustable bracket assembly according to any of clauses 9 to 15, wherein: the adjustable bracket assembly is a first bracket of a bracket set; the bracket set comprises a second bracket; and the second bracket comprises a second hook.

Clause 17. The adjustable bracket assembly of clause 16, wherein the second bracket comprises a locking member movable between a first position, in which the locking member obstructs an opening associated with the second hook, and a second position, in which the opening is not obstructed by the locking member.

Clause 18. A bracket set for securing cargo, the bracket set comprising: a first bracket that is spaced apart, in a first direction, from a second bracket; the first bracket comprising: a mounting plate; and a first hook that releasably attaches to the mounting plate and that, relative to the mounting plate, is movable in the first direction; and the second bracket comprising a second hook.

Clause 19. The bracket set according to clause 18, wherein the first hook comprises a first opening, the second hook comprises a second opening, and the bracket set is configured so that, in use, the first opening and the second opening are each facing in the first direction.

Clause 20. The bracket set according to clause 19, wherein the bracket set is configured so that the first opening and the second opening can, during a different use, be oriented to each face in a second direction opposite the first direction.

Clause 21. A method for restraining a first cart and a second cart to a wall, each cart comprising a horizontal base with a first end and a second end opposite the first end, a first vertical strut extending from the first end and a second vertical strut extending from the second end, each horizontal base comprising a cart length, comprising: coupling a first bracket to a first position on the wall; coupling a second bracket to a second position on the wall a first distance from the first bracket equal to the cart length; coupling a third bracket to the wall a second distance from the second bracket; positioning the first vertical strut of the first cart within a first receiving space of a first hook of the first bracket; positioning the second vertical strut of the first cart within a second receiving space of a second hook of the second bracket; positioning the first vertical strut of the second cart at least partially within the second receiving space; positioning the second vertical strut of the second cart within a third receiving space of a third hook of the third bracket; and actuating a locking member of the third bracket from an open state to a closed state, wherein the second vertical strut of the second cart is inserted into the third receiving space when the locking member is in the open state, and wherein the second vertical strut of the second cart is restrained from forward, rearward and lateral movement relative to the wall when the locking member is in the closed state.

Clause 22. The method according to clause 21, wherein the step of positioning of the first vertical strut of the second cart comprises at least a portion of the second end of the first cart abutting at least a portion of the first end of the second cart.

Clause 23. The method according to clause 22, wherein the first bracket is releasably coupled to the wall.

Clause 24. The method according to clause 23, wherein the first bracket comprises at least one adapter configured to be releasably secured to an aperture in the wall.

Clause 25. The method according to clause 24, wherein the aperture is one of a plurality of apertures regularly spaced along the wall.

Clause 26. The method according to clause 25, wherein the first hook is adjustably affixed to the first bracket.

Clause 27. A method for restraining a plurality of carts arranged serially along a wall, the plurality of carts including a first cart, a last cart, and one or more intervening carts, each cart comprising a horizontal base with a first end and a second end opposite the first end, a first vertical strut extending from the first end and a second vertical strut extending from the second end, comprising: coupling a first bracket to the wall, the first bracket comprising a first hook with a first receiving space; coupling a second bracket to the wall, the second bracket comprising a second hook with a second receiving space; coupling a plurality of intervening brackets to the wall between the first bracket and the second bracket, each intervening bracket comprising an intervening hook with an intervening receiving space; positioning the first cart, comprising the steps of: positioning the first vertical strut of the first cart within the first receiving space, positioning the second vertical strut of the first cart within the intervening receiving space of the intervening hook of the intervening bracket adjacent to the first bracket; positioning the one or more intervening carts serially behind the first cart, comprising the steps of, for each intervening cart: positioning the first vertical strut of the intervening cart at least partially into the intervening receiving space of the intervening hook in which the second vertical strut of the cart immediately adjacent is received; positioning the second vertical strut of the intervening cart within the intervening receiving space of the intervening hook of the next intervening bracket; positioning the last cart, comprising the steps of: positioning the first vertical strut of the last cart at least partially within the intervening receiving space of the intervening hook in which the second vertical strut of the cart immediately adjacent the last cart is received; positioning the second vertical strut of the last cart within the second receiving space; and actuating a locking member of the second bracket from an open state to a closed state, wherein the second vertical strut of the last cart is inserted into the second receiving space when the locking member is in the open state, and wherein the second vertical strut of the last cart is restrained from forward, rearward and lateral movement relative to the wall when the locking member is in the closed state.

Clause 28. The method according to clause 27, wherein at least a portion of the first end of each intervening cart abuts at least a portion of the second end of the cart in front of it and at least a portion of the second end of each intervening cart abuts at least a portion the first end of the cart behind it.

Clause 29. The method according to clause 28, wherein the first bracket is releasably coupled to the wall.

Clause 30. The method according to clause 29, wherein the first hook is adjustably affixed to the first bracket.

Clause 31. An adjustable bracket assembly for securing cargo within a cargo compartment, the adjustable bracket assembly comprising: a bracket comprising a hook; and at least one adapter configured to be releasably secured to a first location within the cargo compartment; wherein: the at least one adapter can be affixed to the bracket in one of a plurality of securement positions on the bracket; and the position of the hook relative to the adapter is different for each of the plurality of securement positions.

While various embodiments of the invention have been described, the invention is not to be restricted except in light of the attached claims and their equivalents. Moreover, the advantages described herein are not the only advantages of the invention and it is not necessarily expected that every embodiment of the invention will achieve all of the advantages described.

1. A system for restraining cargo in a cargo compartment, the system comprising:
a first bracket comprising:
a first hook;
a mounting plate comprising a first side and an opposing second side;
the first hook being releasably affixed to the first side of the mounting plate in one of a plurality of positions along a first linear axis;
at least one first adapter affixed to the second side of the mounting plate and configured to be releasably secured to a first location within the cargo compartment; and
a second bracket comprising:
a second hook comprising a receiving space;
at least one second adapter affixed to the second hook and configured to be releasably secured to a second location within the cargo compartment; and
a locking member having an open state and a closed state, wherein in the closed state, the locking member obstructs the receiving space.

2. The system of claim 1, wherein the first side of the mounting plate comprises a first corrugated surface and a first outer segment of the first hook comprises a complementary second corrugated surface to the first corrugated surface.

3. The system of claim 2, wherein the mounting plate and the first hook are affixed to each other with a releasable fastener and slotted hole connection.

4. The system of claim 3, wherein the slotted hole is disposed in the first outer segment of the first hook.

5. The system of claim 4, wherein the first corrugated surface comprises a first plurality of corrugations with each corrugation having a first longitudinal axis oriented in a vertical direction.

6. The system of claim 5, wherein the slotted hole comprises a second longitudinal axis oriented in a horizontal direction and orthogonal to the first longitudinal axes of the first plurality of corrugations.

7. The system of claim 1, wherein the second bracket comprises a second mounting plate comprising a first side and a second side, the second hook is adjustably affixed to the first side of the second mounting plate, and a second adapter is releasably affixed to the second side of the second mounting plate.

8. The system of claim 1, wherein during use, the first bracket is coupled to a track along a wall within the cargo compartment at a predetermined location forward relative to where the second bracket is coupled to the track.

9. An adjustable bracket assembly for securing cargo, the adjustable bracket assembly comprising:
a mounting plate comprising:
a first side comprising an anchor for releasably attaching the mounting plate to a wall; and
a second side that, relative to the first side, is on an opposite side of the mounting plate; and
a bracket that releasably attaches to the second side of the mounting plate, the bracket comprising:
a third side facing towards the second side; and
a fourth side that, relative to the third side, is on an opposite side of the bracket and that comprises a hook,
wherein the second side and the third side are configured to adjustably interlock with each other.

10. The adjustable bracket assembly of claim 9, wherein the second side comprises a first protuberance.

11. The adjustable bracket assembly of claim 10, wherein the third side comprises a third side surface structure that is configured to adjustably interlock with the first protuberance.

12. The adjustable bracket assembly of claim 11, wherein the third side surface structure comprises least one second protuberance.

13. The adjustable bracket assembly of claim 9, wherein the mounting plate comprises a first aperture, the bracket comprises a second aperture, and the adjustable bracket assembly comprises a releasable fastener coupled to the first aperture and the second aperture.

14. The adjustable bracket assembly of claim 13, wherein the second aperture comprises an elongated slot.

15. The adjustable bracket assembly of claim 14, wherein the elongated slot comprises a countersink.

16. The adjustable bracket assembly of claim 9, wherein:
the adjustable bracket assembly is a first bracket of a bracket set;
the bracket set comprises a second bracket; and
the second bracket comprises a second hook.

17. The adjustable bracket assembly of claim 16, wherein the second bracket comprises a locking member movable between a first position, in which the locking member obstructs an opening associated with the second hook, and a second position, in which the opening is not obstructed by the locking member.

18. A bracket set for securing cargo, the bracket set comprising:
a first bracket that is spaced apart, in a first direction, from a second bracket;
the first bracket comprising:
a mounting plate; and
a first hook that releasably attaches to the mounting plate and that, relative to the mounting plate, is movable in the first direction; and
the second bracket comprising a second hook.

19. The bracket set of claim 18, wherein the first hook comprises a first opening, the second hook comprises a second opening, and the bracket set is configured so that, in use, the first opening and the second opening are each facing in the first direction.

20. The bracket set of claim 19, wherein the bracket set is configured so that the first opening and the second opening can, during a different use, be oriented to each face in a second direction opposite the first direction.
